(19) United States
(12) Patent Application Publication
(10) Pub. No.: US 2004/0120113 A1
(43) Pub. Date: Jun. 24, 2004

(54) Acoustically adaptive thermal management

(75) Inventor: Mark Rapaich, Westfield, IA (US)

Correspondence Address: GATEWAY, INC., ATTN: SCOTT CHARLES RICHARDSON, 610 GATEWAY DRIVE, MAIL DROP Y-04, NORTH SIOUX CITY, SD, 57049, US

(73) Assignee: Gateway, Inc.

(21) Appl. No.: 10/323,184

(22) Filed: Dec. 18, 2002

(51) Int. Cl. G06F 1/20

(52) U.S. Cl. 361/687

(57) ABSTRACT

The present invention is directed to an acoustic management system for an electronic device. The acoustic management system may include an acoustic detection system capable of controlling at least one component of the electronic device. The acoustic detection system is suitable for detecting acoustics generated by the component so that if component acoustics rise above a threshold level or exceed a ratio based on ambient acoustic levels the acoustic detection system may control the component so that component acoustics are varied depending on the situation.

### FIELD OF THE INVENTION

The present invention generally relates to the field of electronics and specifically to acoustics associated with electronics.

### BACKGROUND OF THE INVENTION

Electronics generally and computers in particular include various components which generate noise. In many environments component noise goes unnoticed because environmental noise is greater than the noise generated by the components, thus component noise is masked.

An example of component noise masking occurs when a computer is located in an office environment where other noise exists such as air handlers, adjacent conversations, and urban noise. While component generated noise is generally low in comparison to ambient noise, the overall acoustic level may be improved by reducing or minimizing component noise. In other situations and in particular home use, noise generated by a computer may be intrusive to the user and to others in the general vicinity. For example, if a computer is utilized when ambient noise is extremely low, the noise generated by the components may seem louder resulting in user dissatisfaction.

The main contributor to the overall computer noise is the fan used to cool interior components and processors. Due to the nature of the electronics, large amounts of thermal waste are generated during utilization. Excessive heat build-up can damage components and/or cause components not to function optimally. In order to remove excessive heat from electrical components, manufacturers typically include heat sinks capable of conducting thermal waste from electronic components, and subsequently dissipating the heat into the air. A heat sink may accept a certain amount of thermal waste.

In order to allow usage beyond the free air or passive dissipation limit of a heat sink, a fan is typically included in a computer system to aid in cooling. When implemented fans and heat sinks are typically capable of dissipating thermal energy effectively. One drawback to current cooling systems is that during utilization thermal loads may vary cyclically with general computing processes, thus the cooling system is required to cool rapidly and subsequently may shut-down. While cooling systems are designed to accommodate cyclical thermal loading, the cooling system noise may be intrusive especially if the system is turning off and on.

Electronic devices have implemented thermal detecting systems for activating or monitoring cooling systems in the event of thermal build-up. Thermal protection systems generally activate when the temperature of a component reaches a threshold level. While thermal detection systems prevent overheating, activated cooling systems are noisy and often cycle on and off as thermal waste is generated and subsequently dissipated.

Computer processors and other computer components such as hard drives, floppy drives, DVD, CD-ROM drives also generate noise which in some instances may disturb people in the general area. In order to minimize component noise caused by the need to remove heat generated by the CPU, systems for reducing the clock speed of the processor have been implemented. Current noise reduction systems are based on predictive modeling of processor usage, thus the clock speed is reduced not based on actual conditions but rather based on models of usage. For example, a computer system utilizing predictive techniques may employ clock speed reduction when noise reduction is unnecessary, such as in an office environment.

Present systems fail to reduce the acoustic signature of the various component systems sufficiently to allow for electronics to operate in situations where a premium is placed on low noise. Specifically, in a residential situation or when a notebook computer is utilized in a classroom environment, acoustics generated by fans and processor utilization may intrude on the user's overall experience.

Therefore, it would be desirable to provide a system capable of adaptively managing the acoustics and thermal waste generated by components of an electronic device.

### SUMMARY OF THE INVENTION

Accordingly, the present invention is directed to a system for adaptively managing acoustics and thermal waste associated with electronic devices.

In a first aspect of the present invention an acoustic management system for an electronic device includes an acoustic detection system capable of controlling at least one electronic device component. The acoustic management system is capable of managing acoustics generated by at least one electrical component so that component generated acoustics may be reduced depending on the particular situation such as when the electronic component's acoustic may become annoying to persons adjacent to the electronic device.

In a second aspect of the present invention, an acoustic thermal management system is implemented into an information handling system. The acoustic thermal management system includes a cooling system suitable for generating airflow through a chassis. Coupled to the cooling system is an acoustic detection system capable of controlling the cooling system based on detected acoustics. At least one thermal detector is included in the acoustic thermal management system. A thermal detector is coupled to the acoustic detection systems so that thermal waste may be monitored for components of the information handling system, such as power sources and heat sinks.

In further embodiments, an application specific integrated circuit (ASIC) capable of extracting acoustic information such as frequency versus level is included in the acoustic detection system. The ASIC may be implemented to extract detected acoustic and/or thermal information.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description serve to explain the principles of the invention.

### BRIEF DESCRIPTION OF THE DRAWINGS

The numerous advantages of the present invention may be better understood by those skilled in the art by reference to the accompanying figures in which:

FIG. 1 is a perspective view of an exemplary embodiment wherein an acoustic management system is implemented in an information handling system;

FIG. 2 is a perspective view of an exemplary embodiment wherein an acoustic management system, implemented in an information handling system is capable of controlling an information handling system's processor;

FIG. 3 is a perspective view of an exemplary embodiment wherein an acoustic thermal management system including at least one thermal detector is implemented in an information handling system; and

FIG. 4 is a perspective view of an exemplary embodiment wherein an acoustic management system is suitable for implementation in a portable information handling system.

### DETAILED DESCRIPTION OF THE INVENTION

Reference will now be made in detail to the presently preferred embodiments of the invention, examples of which are illustrated in the accompanying drawings.

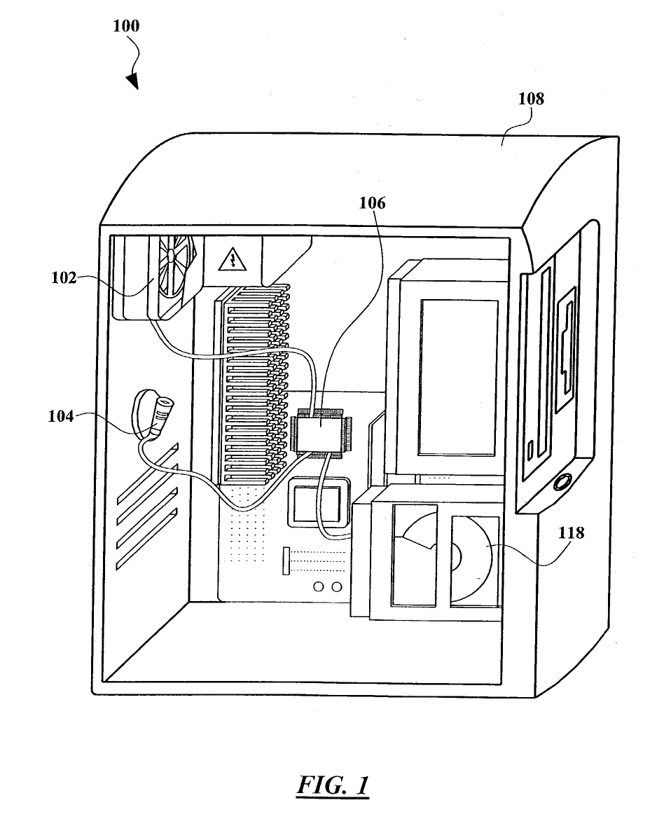

Referring generally now to FIGS. 1 through 4, exemplary embodiments of the present invention are shown wherein a system for adaptively managing the thermal and acoustical aspects of electronic device components are discussed.

Referring to FIG. 1, in a first aspect of the invention an acoustical management system 100 is shown. The acoustical management system 100 includes a cooling system 102. The cooling system 102 is capable of creating a flow of air through the area, such as the information handling system chassis in which the acoustic management system 100 is implemented.

The acoustic management system 100, in the present embodiment is included in an information handling system, in other implementations the acoustic management system of the present invention may be included in notebook computers, electronic devices, such as digital video player, personal video recorders and the like. The acoustic management system 100 is capable of controlling components such as hard drives, floppy drives, optical drives, motors, and output devices.

The airflow generated by the cooling system 102 moves through the chassis aiding in thermal waste removal. Various components such as power sources and electronics generate thermal waste, which must be removed to insure proper operation.

While heat sinks are often implemented in situations involving electronics. Heat sinks in specific applications may not have sufficient capacity or are undesirable for manufacturing reasons, thus cooling systems are utilized and may be used in conjunction with heat sinks. Cooling systems 102 drawing air through the chassis may reduce thermal waste from the components generating heat as well as from associated heat sinks.

Coupled to the cooling system is an acoustic detection system. The acoustic detection system is capable of detecting acoustics such as noise generated by a component hard drive 118 and the like. The acoustic detecting system includes a microphone 104. The location of the acoustic detection system may vary depending on various considerations as contemplated by one of ordinary skill in the art. For example, the microphone 104 may be located outside the information handling system chassis 108 and may include other functional purposes such as for providing input to the information handling system.

The acoustic detection system in general forms a feedback loop which may detect the acoustics generated by the cooling system processors and the like. Furthermore, the acoustic detection system in implementations is capable of detecting ambient acoustics. In this fashion the acoustic management system may implement passive acoustic reduction for the associated component when necessary. Passive acoustic reduction may be employed when a component generates noise or waste acoustics. Resulting from this environmental detection capability the acoustic management system 100 may be capable of dynamically determining if passive acoustic reduction is necessary. Passive acoustic reduction is achieved by reducing the acoustics generated by the component rather than generating a sound wave to cancel component generated acoustics.

In environments where ambient acoustics exceed component acoustic, the management system may not implement acoustic reduction for the component. Conversely, in an environment where the ambient acoustic level is low the acoustic management system may reduce the acoustics generated by the component.

In additional embodiments, the acoustic detection system 100 includes an application specific integrated circuit (ASIC) 106 capable of extracting acoustic information. In the present example the system management ASIC of an information handling system may be utilized to extract acoustic information. The acoustic detection system is capable of utilizing detected acoustics to determine if for example the cooling system should be turned on, turned off, or varied depending on ambient acoustic level and component acoustic levels. The ASIC 106 may extract acoustic information including level, frequency and the like, for example by applying fast Fourier transform (FFT) to acoustic data.

The acoustic detection system effectively passively controls the cooling system acoustics by controlling the cooling system itself. As a result of the acoustic detection system controlling the cooling system 102 the acoustics may be quieted by lowering the cooling system or turning the cooling system off entirely. Additionally, the cooling system 102 may be ramped up to allow for gradual increase in acoustic so that the increase in noise is not abrupt or continually cycling. Thus people adjacent to the device implementing the acoustic thermal management system 100 may not notice the gradual change.

Moreover, including a cooling system which is capable of selectively varying the rate of cooling allows for initiating cooling earlier in the computing cycle when the total amount of thermal waste generated is lower, thus eliminating a larger heat load later in the computing cycle when it may require a higher cooling level and correspondingly a higher level of acoustic generated as the cooling system operates.

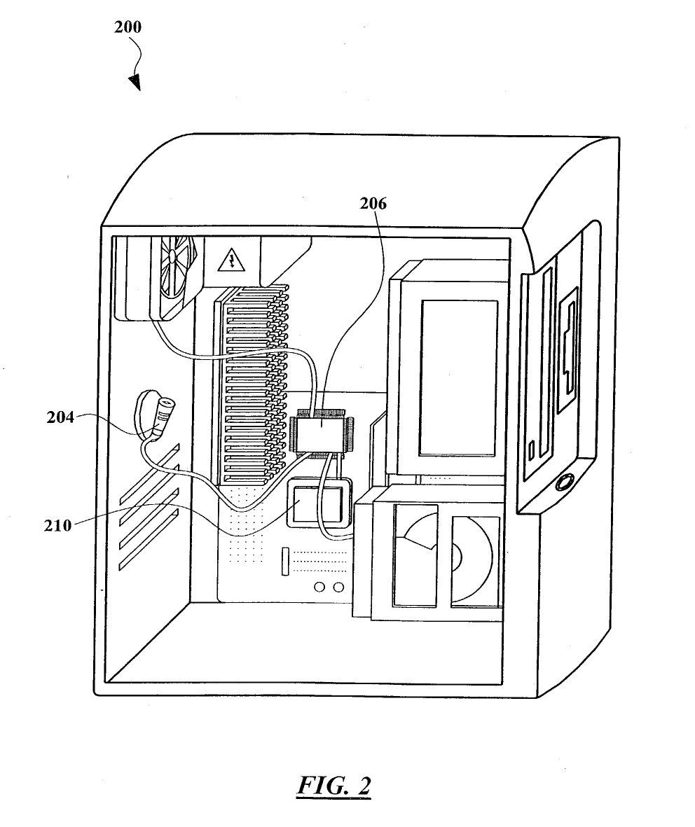

Referring to FIG. 2, in a second aspect of the invention, an acoustic detection system 200 is capable of altering the clock speed of a processor 210 included in an information handling system in which the acoustic management system 200 is implemented. The processor's clock speed may be slowed down depending on if processor generated acoustic, exceed a specific threshold generally or in comparison to the environmental acoustic level. The acoustic detection system includes a microphone 204 and ASIC 206 which is coupled to the information handling system processor 210.

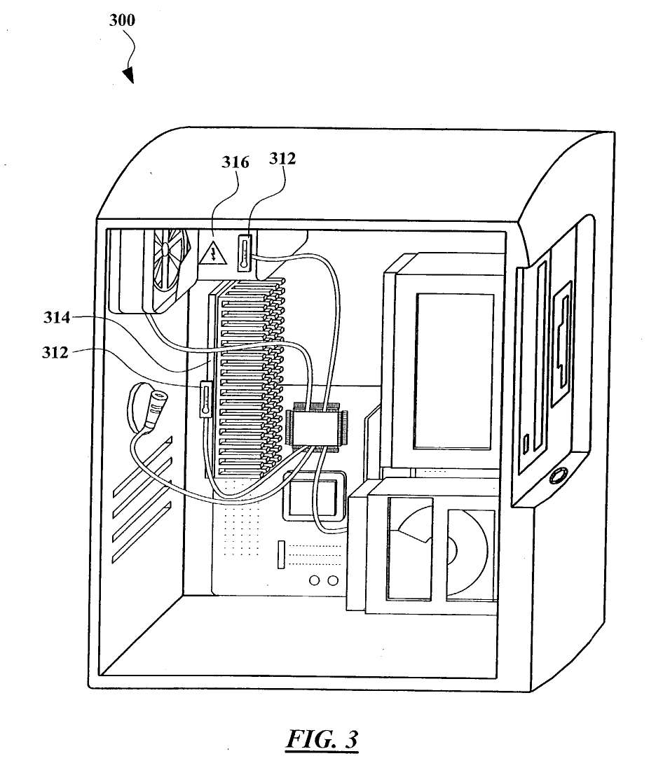

Referring now to FIG. 3, an acoustic thermal management system 300 of the present invention further includes at least one thermal detector. The thermal detector 312 may be directly associated with a specific component such as a power source 316 a heat sink 314 and the like. The thermal detector 312 is capable of determining the temperature associated with the particular device.

The thermal detector 312 is communicatively coupled to the acoustic detection system so that the acoustic detector system may utilize the detected thermal information in conjunction with acoustical information such that if the device or area associated with the thermal detector 312 exceeds a threshold level the acoustic system controls the cooling system in a manner to prevent overheating while minimizing acoustics associated with cooling.

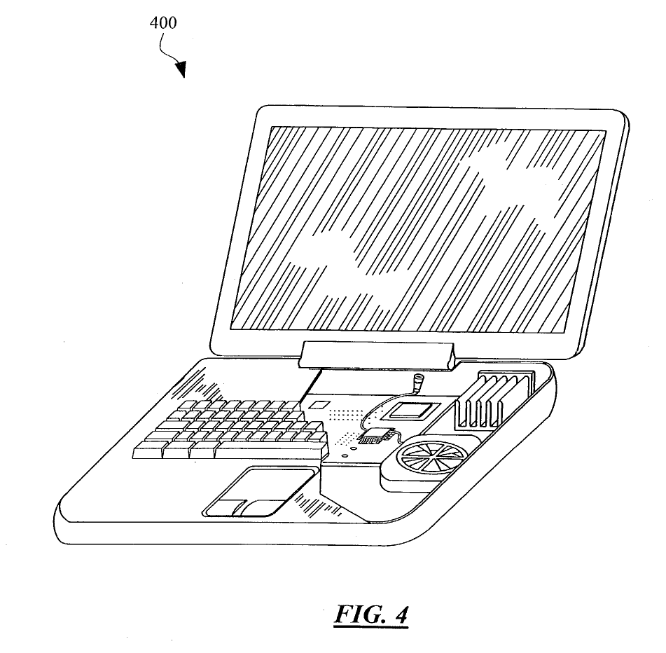

Referring generally to FIG. 4, in a further aspect of the invention the acoustic management system is implemented in a portable information handling system 400. In the present aspect the acoustic management system is capable of controlling the hard drive, floppy drive, processor and cooling system.

It is believed that the acoustically adaptive thermal management of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An acoustic management system for an electronic device comprising:
at least one component of an electronic device;
an acoustic detection system capable of detecting acoustics coupled to the at least one electronic device component;
wherein the acoustic detection system controls the at least one electronic device component such that the acoustic detection system is capable of passively controlling waste acoustics generated by the at least one electronic device component.

2. The acoustic management system for an electronic device of claim 1, wherein the acoustic detection system includes an application specific integrated circuit capable of extracting acoustic information from detected acoustics.

3. The acoustic management system for an electronic device of claim 1, wherein the acoustic detection system is capable of controlling an electronic device's central processing unit.

4. The acoustic management system for an electronic device of claim 1, wherein the acoustic detection system is capable of comparing environmental acoustics to acoustics generated by the at least one electronic device component, such that the at least one electronic device component generated waste acoustics are reduced to substantially environmental acoustic levels.

5. The acoustic management system for an electronic device of claim 4, wherein one of the at least one electronic device component is a hard drive, a floppy drive, an optical disk drive, a motor and an output device.

6. The acoustic management system for an electronic device of claim 1, wherein the acoustic detection system is capable of controlling operation of an electronic device's cooling system.

7. The acoustic management system for an information handling system of claim 1, wherein the electronic device is portable.

8. An acoustic thermal management system for an information handling system comprising:
a cooling system suitable for generating airflow through a chassis; and
an acoustic detection system capable of detecting acoustics coupled to said cooling system;
wherein the acoustic detection system controls said cooling system such that the acoustic detection system is capable of passively controlling the acoustics generated by said cooling system.

9. The acoustic thermal management system for an information handling system of claim 8, wherein the acoustic detection system includes an application specific integrated circuit capable of extracting acoustic information from detected acoustics.

10. The acoustic thermal management system for an information handling system of claim 8, wherein the acoustic detection system is capable of comparing environmental acoustics to acoustic thermal management system generated acoustics, such that acoustical thermal management system acoustics are reduced to substantially environmental acoustic levels.

11. The acoustic thermal management system for an information handling system of claim 8, wherein the acoustic detection system is capable of altering the level at which the cooling system operates.

12. An acoustic thermal management system for an information handling system comprising:
a cooling system suitable for generating airflow through an information handling system chassis;
an acoustic detection system capable of detecting acoustics coupled to said cooling system; and
at least one thermal detector capable of determining temperature, said thermal detector is communicatively coupled to said acoustic detection system such that determined temperature is implemented in controlling said cooling system;
wherein the acoustic detection system controls said cooling system such that the acoustic detection system is capable of passively controlling the acoustics generated by said cooling system.

13. The acoustic management system for an information handling system of claim 12, wherein the acoustic detection system includes an application specific integrated circuit capable of extracting acoustic information from detected acoustics.

14. The acoustic management system for an information handling system of claim 12, wherein the acoustic detection system is capable of comparing environmental acoustics to acoustic thermal management system generated acoustics, such that acoustical thermal management system acoustics are reduced to substantially environmental acoustic levels.

15. The acoustic management system for an information handling system of claim 12, wherein the acoustic detection system is capable of controlling an information handling system's central processing unit.

16. The acoustic management system for an information handling system of claim 12, wherein the acoustic detection system is capable of altering the level at which the cooling system operates.

17. The acoustic management system for an information handling system of claim 12, wherein the information handling system is portable.

18. An acoustic thermal management system for an information handling system comprising:
a means for generating a flow of air suitable for cooling at least one information handling system component;
a means for detecting acoustics coupled to said airflow generating means;
wherein the acoustic detection means controls said airflow generating means such that the acoustic detecting means is capable of passively controlling the acoustics generated by said airflow generating means.

19. The acoustic management system for an information handling system of claim 18, wherein the acoustic detecting means includes an application specific integrated circuit capable of extracting acoustic information from detected acoustics.

20. The acoustic management system for an information handling system of claim 18, wherein the acoustic detecting means is capable of comparing environmental acoustics to acoustic thermal management system generated acoustics.

21. The acoustic management system for an information handling system of claim 18, wherein the acoustic detecting means is capable of controlling an information handling system's central processing unit.

22. The acoustic management system for an information handling system of claim 18, wherein the acoustic detecting means is capable of altering the level at which the airflow generating means operates.

23. The acoustic management system for an information handling system of claim 18, wherein the information handling system is portable.
